(19) United States
(12) Patent Application Publication
(10) Pub. No.: US 2026/0167031 A1
(43) Pub. Date: Jun. 18, 2026

(54) CHARGING DEVICE

(71) Applicant: LG ELECTRONICS INC., Seoul (KR)

(72) Inventors: Suk KO, Seoul (KR); Cheolhong PARK, Seoul (KR); Sunghwan OH, Seoul (KR); Myoungku LEE, Seoul (KR); Seungwon LEE, Seoul (KR)

(73) Assignee: LG ELECTRONICS INC., Seoul (KR)

(21) Appl. No.: 19/186,200

(22) Filed: Apr. 22, 2025

(30) Foreign Application Priority Data
Dec. 18, 2024 (KR) 10-2024-0189645

(51) Int. Cl. B60L 53/31; B60L 53/67; H02B 1/04; H02B 1/20; H02B 1/32

(52) U.S. Cl. CPC B60L 53/31; H02B 1/042; H02B 1/20; H02B 1/32; B60L 53/67

(57) ABSTRACT

Disclosed is a charging device including a casing where a power module is mounted and an accommodation space where an input module and an output module electrically connected to the power module are located is defined, and an inner plate partitioning the accommodation space of the casing, having the input module disposed on one surface thereof, and having the output module disposed on an opposite surface thereof, wherein the input module is detachably coupled to the one surface of the inner plate in a selective manner, and the output module is detachably coupled to the opposite surface of the inner plate in a selective manner.

### CROSS REFERENCE TO RELATED APPLICATION

Pursuant to 35 U.S.C. § 119(a), this application claims the benefit of earlier filing date and right of priority to Korean Patent Application No. 10-2024-0189645, filed on Dec. 18, 2024, the contents of which are hereby incorporated by reference herein in its entirety.

### BACKGROUND

### Field

The present disclosure relates to a charging device for charging an electric vehicle that may be commonly used as some components of an input module and an output module, which are electrically connected to a power module, are mounted in a replaceable manner based on specifications.

### Discussion of the Related Art

In general, an electric vehicle (EV) has not been put into practical use for a long time because of problems such as a great weight of a battery mounted in the vehicle and a time it takes to charge when compared to a gasoline or diesel vehicle. However, recently, because of a depletion of fossil energy and environmental pollution, interest in the electric vehicle that does not use the fossil energy but uses electric energy has increased, and research and development on the electric vehicle have been actively conducted.

As a result, popularization of the electric vehicle has been increasing recently. The electric vehicle has a battery that supplies power for operation thereof, and has a structure in which the power is stored in the battery. Therefore, to continuously operate the electric vehicle, the battery must be charged. Accordingly, an infrastructure for charging the electric vehicle is needed, and fixed standing charging facilities are being established in various locations to meet an increasing demand for the electric vehicle.

Charging facilities for the electric vehicle include a split charging facility and an integrated charging facility. The split charging facility includes a power cabinet in which multiple electronic components including a power module are mounted in a box-shaped casing, and a dispenser that receives power from the power cabinet and charges the electric vehicle. In the integrated charging facility, the above-described dispenser and power cabinet constitute a single body and are integrally formed to charge the electric vehicle.

In this regard, it is required to secure a space for installing the charging facility for the electric vehicle. To this end, there is a need for a structural means capable of reducing a size of the casing in which the multiple electronic components are mounted. For example, a method of efficiently utilizing an accommodation space in which the electronic components are mounted by changing an arrangement structure of the electronic components mounted in the casing may be considered.

In addition, in the case of charging facility, required standards and specifications may be different based on a country of use. Therefore, to reduce a cost of building an infrastructure for charging the electric vehicle and improve operational efficiency, a method for making the charging facility available to the public is required.

### SUMMARY

The present disclosure relates to a charging device, and more particularly, to a charging device that may be commonly used as some components of an input module and an output module, which are electrically connected to a power module, are mounted in a replaceable manner based on specifications.

In addition, the present disclosure is to provide a charging device that may efficiently arrange multiple electronic components by partitioning an accommodation space via an inner plate to place an input module on one surface of the inner plate and an output module on the other surface of the inner plate.

In addition, the present disclosure is to provide a charging device that may sufficiently secure a connection space of a power cable for supplying power to a plurality of dispensers by securing a placement space of an output module via an inner plate partitioning an accommodation space.

The problems to be solved by the present disclosure are not limited to the above-mentioned technical problems, and other technical problems not mentioned will be clearly understood by those skilled in the art to which the present disclosure pertains from the following description.

Provided is a charging device including a casing where a power module is mounted and an accommodation space where an input module and an output module electrically connected to the power module are located is defined, and an inner plate partitioning the accommodation space of the casing, having the input module disposed on one surface thereof, and having the output module disposed on an opposite surface thereof, wherein the input module is detachably coupled to the one surface of the inner plate in a selective manner, and the output module is detachably coupled to the opposite surface of the inner plate in a selective manner.

The input module may include a common input module coupled to and fixed to the one surface of the inner plate, and a dedicated input module detachably fastened to the one surface of the inner plate.

The dedicated input module may include a power cut-off that blocks power of the power module, and a fastening portion coupled with the power cut-off portion and detachably fastened to the one surface of the inner plate.

The power cut-off may include a magnet contactor electrically connected to the power module, and a molded case circuit breaker electrically connected to the magnet contactor.

The power cut-off may include a first power cut-off and a second power cut-off having different specifications.

The fastening portion may include a first fastening portion coupled with the first power cut-off and a second fastening portion coupled with the second power cut-off.

The dedicated input module may include a first input bus bar electrically connecting the power module with the magnet contactor, and a second input bus bar electrically connecting an external power source with the molded case circuit breaker.

The fastening portion may include a first fastening bracket coupled with the first input bus bar, a second fastening bracket coupled with the second input bus bar, and a third fastening bracket coupled with the magnet contactor and the molded case circuit breaker.

The common input module may include a cable connection portion for electrically connecting the power module with the dedicated input module, and an earth leakage circuit breaker for blocking a leakage current.

The inner plate may include a plurality of fastening grooves defined in the opposite surface thereof for the output module to be detachably fastened.

The output module may include a first output bus bar electrically connected to the power module, a second output bus bar coupled with an output terminal electrically connected with a power cable, and a first relay electrically connecting the first output bus bar with the second output bus bar, wherein the first relay is fastened to the plurality of fastening grooves.

The output module may include a first fixing bracket coupled with the second output bus bar and fastened to the plurality of fastening grooves.

The output module may include a second fixing bracket coupled with the first output bus bar and fastened to the plurality of fastening grooves.

The first relay may include a plurality of first relays fastened to the plurality of fastening grooves, and the first output bus bar and the second output bus bar may respectively include a plurality of first output bus bars and a plurality of second output bus bars electrically connected to each other via the plurality of first relays.

The output module may include a second relay electrically connecting the plurality of first output bars to each other and fastened to the plurality of fastening grooves.

The output terminal may include a first output terminal and a second output terminal having different specifications.

The casing may be formed in a shape with open front and rear sides, and the inner plate may partition the accommodation space of the casing in a front and rear direction.

The accommodation space of the casing may be defined under the mounted power module.

The charging device may further include a dispenser that receives power converted via the power module and charges an electric vehicle.

The dispenser may include a plurality of dispensers that receive the power via a plurality of power cables connected to the output module.

The charging device according to the present disclosure may be commonly used as some components of the input module and the output module, which are electrically connected to the power module, are mounted in a replaceable manner based on the specifications.

In addition, the multiple electronic components may be efficiently arranged by partitioning the accommodation space via the inner plate to place the input module on the one surface of the inner plate and the output module on the other surface of the inner plate.

In addition, the connection space of the power cable for supplying the power to the plurality of dispensers may be sufficiently secured by securing the placement space of the output module via the inner plate partitioning the accommodation space.

The effects obtainable in the present disclosure are not limited to the above-mentioned effects, and other effects not mentioned will be clearly understood by those skilled in the art to which the present disclosure pertains from the following description.

### BRIEF DESCRIPTION OF THE DRAWINGS

FIG. 1 is a view illustrating a charging device according to an embodiment of the present disclosure.

FIG. 2 is a view illustrating a casing equipped with an inner plate partitioning an accommodation space in a charging device according to an embodiment of the present disclosure.

FIG. 3 is a front view of a power cabinet of a charging device according to an embodiment of the present disclosure.

FIG. 4 is a rear view of a power cabinet of a charging device according to an embodiment of the present disclosure.

FIG. 5 is a view illustrating an input module disposed on one surface of an inner plate in a charging device according to an embodiment of the present disclosure.

FIG. 6 is a view illustrating a first fastening portion to which a first power cut-off is coupled in a charging device according to an embodiment of the present disclosure.

FIG. 7 is a view illustrating a second fastening portion to which a second power cut-off is coupled in a charging device according to an embodiment of the present disclosure.

FIG. 8 is an exploded view of FIG. 6.

FIG. 9 is an exploded view of FIG. 7.

FIG. 10 is an exploded view of an output module disposed on the other surface of an inner plate in a charging device according to an embodiment of the present disclosure.

FIG. 11 is an exploded view of an output module according to another embodiment disposed on the other surface of an inner plate in a charging device of the present disclosure.

### DESCRIPTION OF SPECIFIC EMBODIMENTS

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

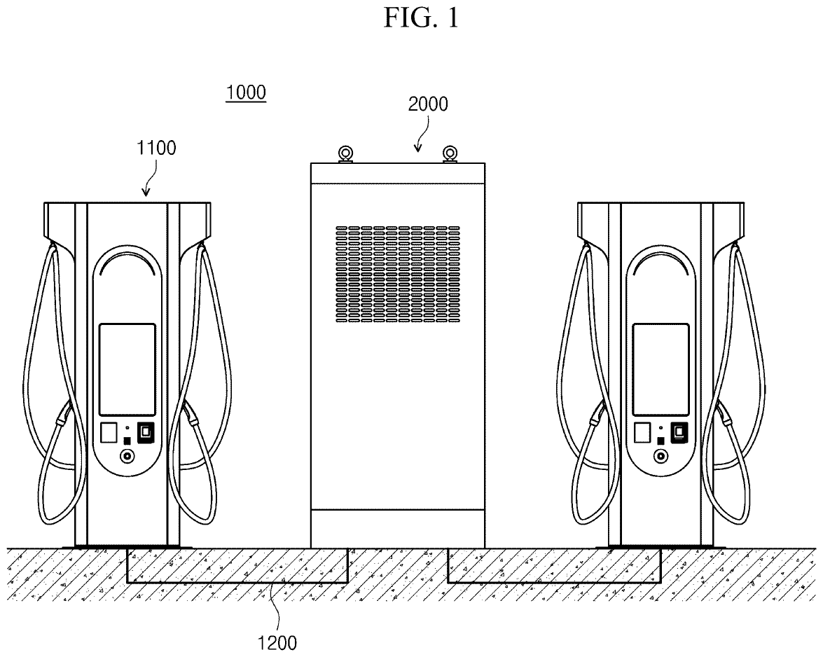

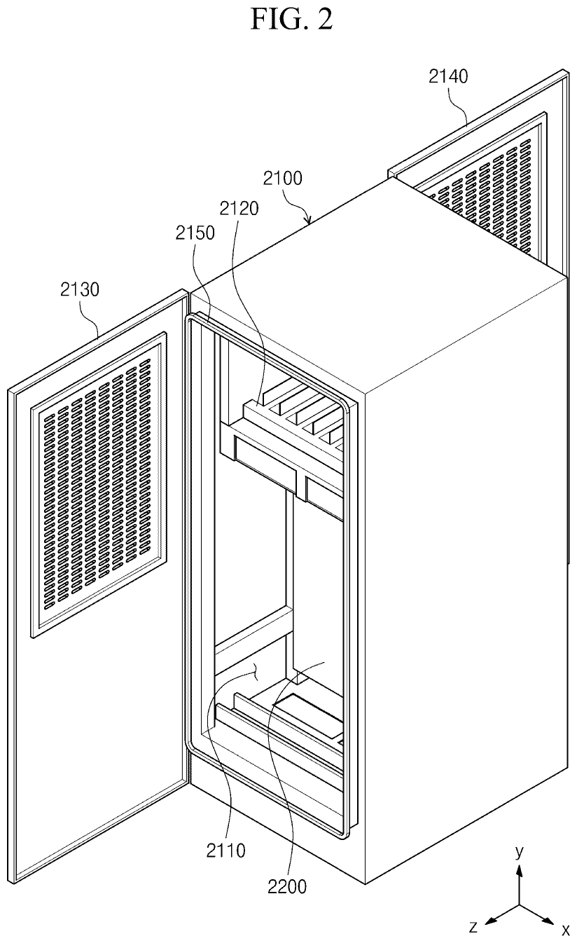

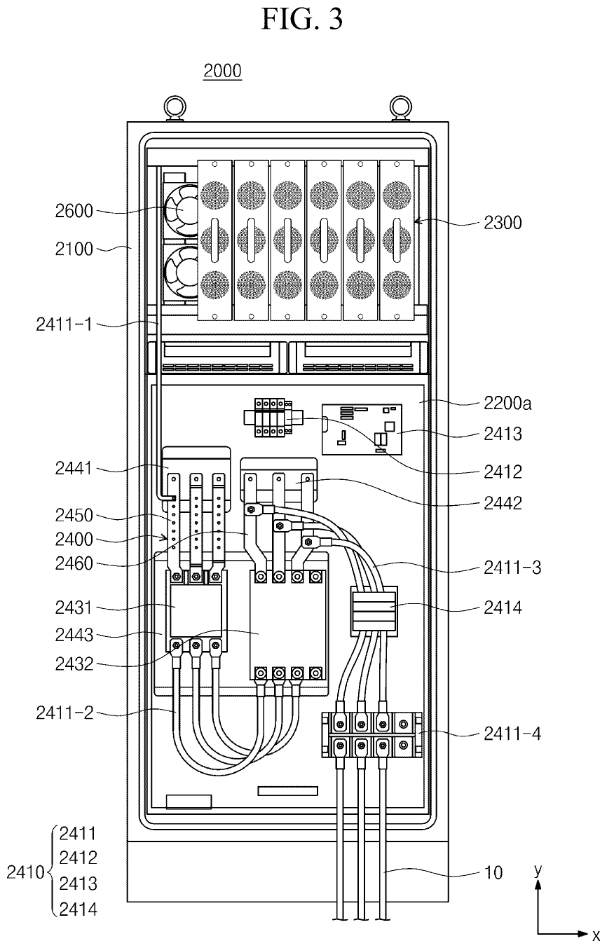

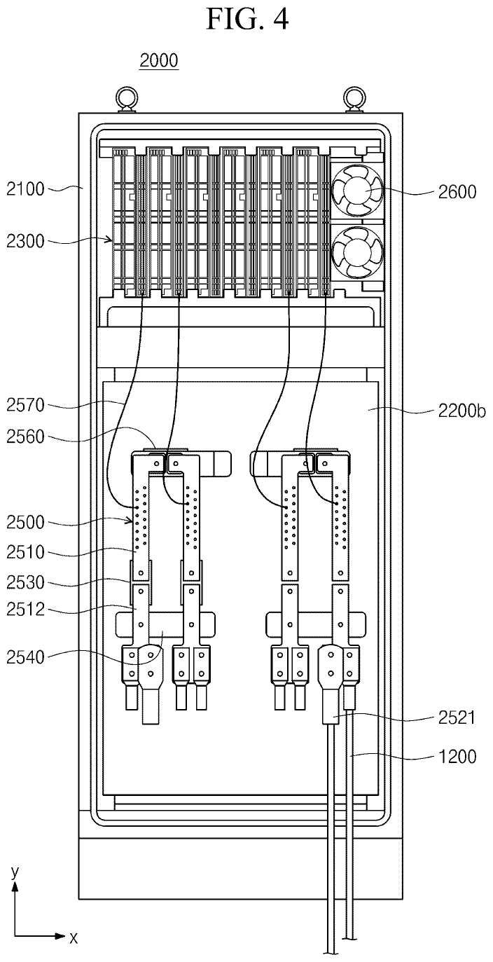

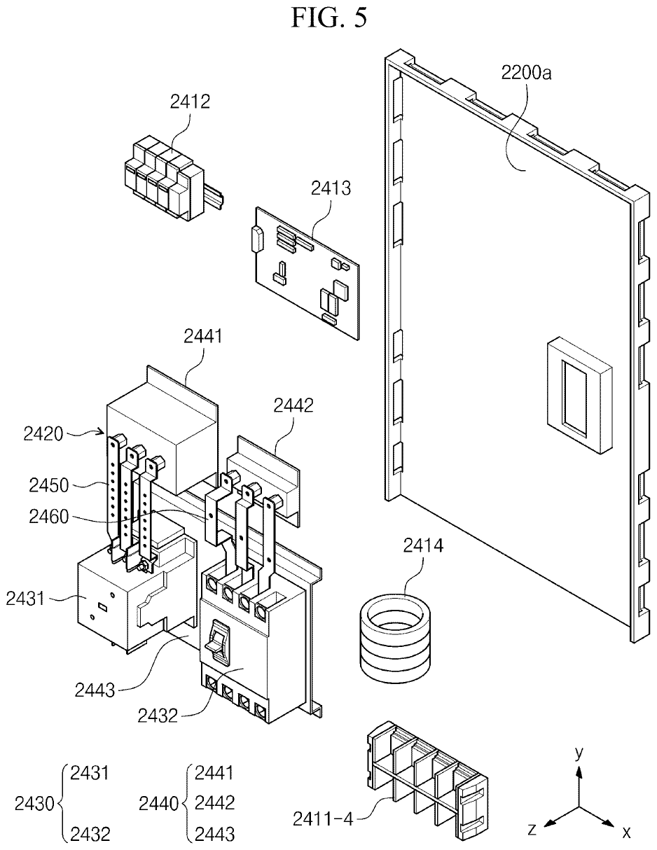

FIG. 1 is a view illustrating a charging device 1000 according to an embodiment of the present disclosure. FIG. 2 is a view illustrating a casing 2100 equipped with an inner plate 2200 partitioning an accommodation space 2110 in the charging device 1000 according to an embodiment of the present disclosure. FIG. 3 is a front view of a power cabinet 2000 of the charging device 1000 according to an embodiment of the present disclosure. FIG. 4 is a rear view of the power cabinet 2000 of the charging device 1000 according to an embodiment of the present disclosure. Further, FIG. 5 is a view illustrating an input module 2400 disposed on one surface 2200a of the inner plate 2200 in the charging device 1000 according to an embodiment of the present disclosure.

Hereinafter, in describing the charging device 1000 according to an embodiment of the present disclosure, a left and right direction will be referred to as an x-axis direction, a vertical direction as a y-axis direction, and a front and rear direction as a z-axis direction.

As described above, charging facilities of an electric vehicle may be categorized into a split charging facility and an integrated charging facility. The split charging facility may include a power cabinet in which multiple electronic components including a power module are mounted in a box-shaped casing, and a dispenser that receives power from the power cabinet and charges the electric vehicle. In the integrated charging facility, the above-described dispenser and power cabinet may constitute a single body and be integrally formed to perform charging of the electric vehicle.

Further, the charging device 1000 of the present disclosure may have a structure applicable to both the above-described split charging facility and integrated charging facility.

In addition, the charging device 1000 of the present disclosure may correspond to the power cabinet in the above-described split charging facility. In addition, the charging device 1000 of the present disclosure may correspond to the dispenser in the above-described split charging facility. That is, the charging device 1000 of the present disclosure to be described later may have a structure applicable to both the power cabinet and the dispenser in the split charging facility.

FIG. 1 is a view illustrating the split charging facility among the charging facilities described above. As illustrated in FIG. 1, the charging device 1000 according to an embodiment of the present disclosure may include the dispenser 1100 that receives the power and charges the electric vehicle (EV), and the power cabinet 2000 that supplies the power to the dispenser 1100. Further, the dispenser 1100 may receive the power via a power cable 1200 connected to the power cabinet 2000. In this regard, a plurality of dispensers 1100 may be disposed as illustrated in FIG. 1, and the power cabinet 2000 may supply the power to the plurality of dispensers 1100 via the power cable 1200.

Referring to FIGS. 2 to 4 together, in the charging device 1000 according to an embodiment of the present disclosure, the power cabinet 2000 may include the casing 2100 in which a power module 2300 is mounted and the accommodation space 2110 in which the input module 2400 and an output module 2500 electrically connected to the power module 2300 are located is defined.

The power module 2300 may serve to convert power supplied from an external power source into the power for charging the electric vehicle. In addition, the power converted by the power module 2300 may be supplied to the dispenser 1100 via the output module 2500. In this case, the input module 2400 may be electrically connected to the external power source, and may control operation of the power module 2300.

In addition, in the charging device 1000 according to an embodiment of the present disclosure, the power cabinet 2000 may include the inner plate 2200 that partitions the accommodation space 2110 of the casing 2100, has the input module 2400 disposed on one surface 2200a thereof, and has the output module 2500 disposed on the other surface 2200b thereof.

In particular, in the charging device 1000 according to an embodiment of the present disclosure, the input module 2400 may be detachably coupled to the one surface 2200a of the inner plate 2200 in a selective manner in the power cabinet 2000, and the output module 2500 may be detachably coupled to the other surface 2200b of the inner plate 2200 in a selective manner.

This is to more efficiently utilize the accommodation space 2110 of the casing 2100 in which the multiple electronic components are mounted as described above, and to reduce a cost of building an infrastructure for charging the electric vehicle and improve operational efficiency via common use of the power cabinet 2000 that supplies the power to the dispenser 1100.

More specifically, as illustrated in FIG. 2, in the charging device 1000 according to an embodiment of the present disclosure, the casing 2100 may include a shelf member 2120 for mounting the power module 2300. In addition, the accommodation space 2110 may be partitioned via the inner plate 2200.

In this regard, in the charging device 1000 according to an embodiment of the present disclosure, the casing 2100 may be formed in a form in which front and rear sides are opened. In addition, the inner plate 2200 may partition the accommodation space 2110 of the casing 2100 in the front and rear direction (the z-axis direction). Accordingly, the one surface 2200a of the inner plate 2200 may be a front surface of the inner plate 2200, and the other surface 2200b of the inner plate 2200 may be a rear surface of the inner plate 2200. In this case, the input module 2400 may be disposed in a front side of the accommodation space 2110 partitioned in the front and rear direction (the z-axis direction), and the output module 2500 may be disposed in a rear side.

In addition, in the charging device 1000 according to an embodiment of the present disclosure, the accommodation space 2110 of the casing 2100 may be located under the mounted power module 2300. This is to facilitate removal and fastening of the dedicated input module 2420 at the one surface 2200a of the inner plate 2200 to be described later, and removal and fastening of the output module 2500 at the other surface 2200b of the inner plate 2200.

Additionally, in the charging device 1000 according to an embodiment of the present disclosure, the casing 2100 may include a front door 2130 coupled to be opened and closed from the front, and may include a rear door 2140 coupled to be opened and closed from the rear. In this case, the casing 2100 may include a sealing member 2150 coupled along peripheries of the front surface and the rear surface.

In addition, the front door 2130 and the rear door 2140 are coupled to the casing 2100 via the sealing member 2150 and block a gap that may occur, thereby securing electrical stability or the like via a waterproof structure.

Furthermore, in the charging device 1000 according to an embodiment of the present disclosure, as illustrated in FIGS. 3 and 4, a blower 2600 may be disposed in a space in which the power module 2300 is mounted. The blower 2600 may serve to circulate internal air and at the same time may serve to discharge heat generated by the power module 2300 to the outside. To this end, as illustrated in FIG. 2, multiple holes for inflow and outflow of air may be defined in the front door 2130 and the rear door 2140.

In the charging device 1000 according to an embodiment of the present disclosure, the input module 2400 may include a common input module 2410 and a dedicated input module 2420. In this regard, the common input module 2410 may be coupled and fixed to the one surface 2200a of the inner plate 2200. In addition, the dedicated input module 2420 may be detachably fastened to the one surface 2200a of the inner plate 2200.

As described above, the charging device 1000 according to an embodiment of the present disclosure aims to reduce the infrastructure building cost for charging the electric vehicle and improve the operational efficiency via the common use of the power cabinet 2000. To this end, the charging device 1000 according to an embodiment of the present disclosure may allow the charging of the electric vehicle to be achieved by supplying the power to the dispenser 1100 by replacing only the dedicated input module 2420 based on standards or specifications required for each country of use.

Referring to FIGS. 3 and 5 together, in the charging device 1000 according to an embodiment of the present disclosure, the dedicated input module 2420 may be detachably fastened to the one surface 2200a of the inner plate 2200. In this regard, the dedicated input module 2420 may include a power cut-off 2430 that cuts off the power of the power module 2300. In addition, the dedicated input module 2420 may include a fastening portion 2440 that is coupled with the power cut-off 2430 and is detachably fastened to the one surface 2200a of the inner plate 2200.

Because the power cut-off 2430 serving to cut off the power of the power module 2300 has different specifications depending on the country of use, the common use of the power cabinet 2000 according to an embodiment of the present disclosure may be achieved via replacement of the power cut-off 2430.

In this regard, the power cut-off 2430 may include a magnet contactor (MC) 2431 electrically connected to the power module 2300, and a molded case molded case circuit breaker (MCCB) 2432 electrically connected to the magnet contactor 2431.

In addition, in the charging device 1000 according to an embodiment of the present disclosure, the dedicated input module 2420 may include a first input bus bar 2450 electrically connecting the power module 2300 with the magnet contactor 2431 and a second input bus bar 2460 electrically connecting the external power source with the molded case circuit breaker 2432.

Further, the fastening portion 2440 may include a first fastening bracket 2441 to which the first input bus bar 2450 is coupled, a second fastening bracket 2442 to which the second input bus bar 2460 is coupled, and a third fastening bracket 2443 to which the magnet contactor 2431 and the molded case circuit breaker 2432 are coupled.

That is, the charging device 1000 according to an embodiment of the present disclosure may replace the fastening portion 2440 to which the power cut-off 2430 having the different specifications depending on the country of use is coupled, the first input bus bar 2450, the second input bus bar 2460, and the third input bus bar at the one surface 2200a of the inner plate 2200. Accordingly, the common use of the power cabinet 2000 may be achieved.

A more detailed description of the replacement of the dedicated input module 2420 for common use of the charging device 1000 according to an embodiment of the present disclosure will be made later.

Referring again to FIG. 3 together, in the charging device 1000 according to an embodiment of the present disclosure, the common input module 2410 may be coupled and fixed to the one surface 2200a of the inner plate 2200. That is, the common input module 2410 may include common components that do not have different specifications depending on the country of use.

First, the common input module 2410 may include a cable connection portion 2411. In this regard, the cable connection portion 2411 may include a cable 241 first-first electrically connecting the power module 2300 with the first input bus bar 2450, a cable 241 first-second electrically connecting the magnet contactor 2431 with the molded case circuit breaker 2432, a cable 2411-3 electrically connected to the second input bus bar 2460, and a connection terminal 2411-4 electrically connecting the cable 10 connected to the external power source with the cable 2411-4 connected to the second input bus bar 2460.

In addition, the common input module 2410 may include an earth leakage circuit breaker (ELCB) 2412 for blocking a leakage current. Furthermore, a fixing member 2414 that fixes a printed circuit board 2413 and the above-described cable connection portion 2411 may be included. As described above, in the charging device 1000 according to an embodiment of the present disclosure, the common input module 2410 may include the common components that do not have the different specifications depending on the country of use.

Referring to FIG. 4, in the charging device 1000 according to an embodiment of the present disclosure, the output module 2500 may include a first output bus bar 2510 electrically connected to the power module 2300, and a second output bus bar 2520 to which an output terminal 2521 electrically connected with the power cable 1200 is coupled. In addition, a first relay 2530 electrically connecting the first output bus bar 2510 with the second output bus bar 2520 may be included. In addition, the output module 2500 may include a cable 2570 for electrically connecting the power module 2300 with the first output bus bar 2510. As described above with reference to FIG. 1, the power cable 1200 for supplying the power to the dispenser 1100 may be connected to the output terminal 2521.

In particular, in the charging device 1000 according to an embodiment of the present disclosure, the output module 2500 may be disposed on the other surface 2200b of the inner plate 2200 by partitioning the accommodation space 2110 of the casing 2100 via the inner plate 2200. In addition, a placement space of the output module 2500 may be secured via the inner plate 2200 partitioning the accommodation space 2110.

Therefore, as shown in FIG. 4, the charging device 1000 according to an embodiment of the present disclosure may secure a structure advantageous for placing a plurality of output terminals 2521. In addition, by connecting the power cable 1200 to the plurality of output terminals 2521, the power may be supplied to the at least one dispenser 1100 as described above with reference to FIG. 1, and the charging of the electric vehicle may be performed. More details thereof will be described later.

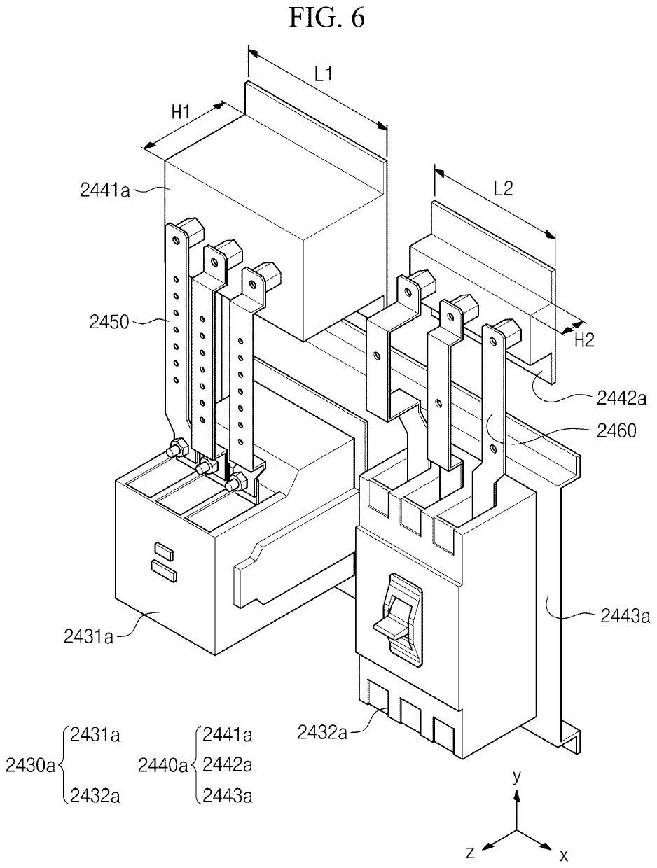

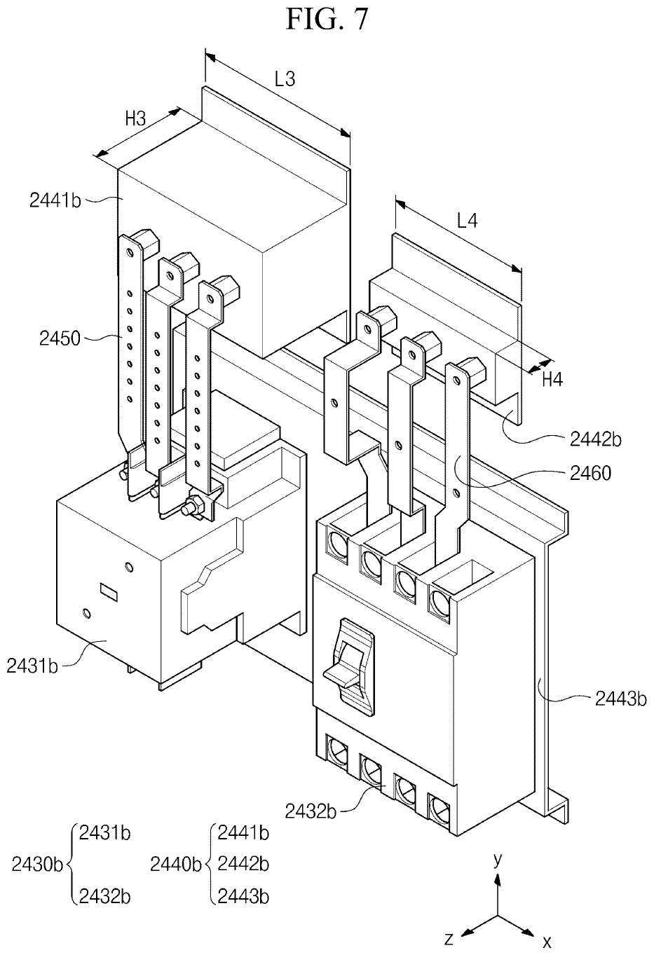

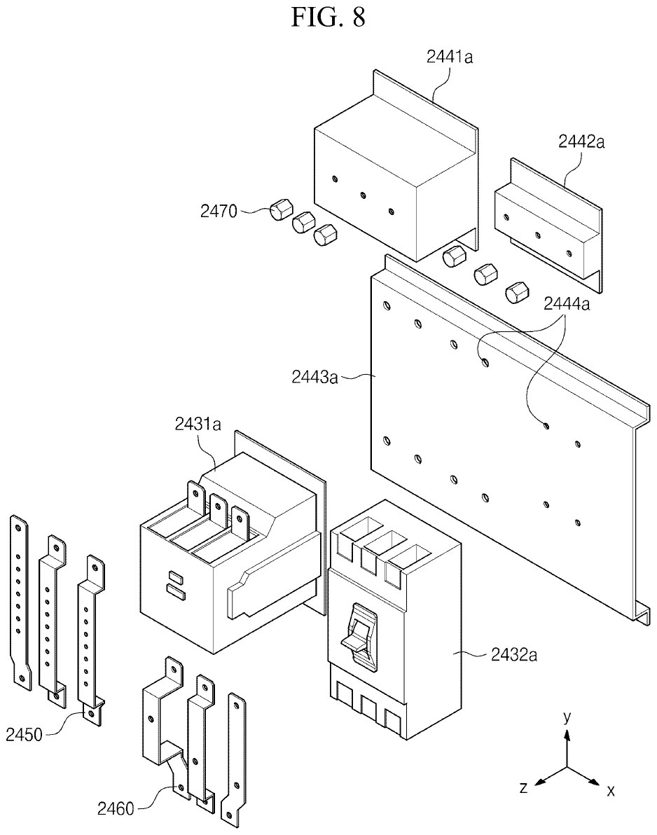

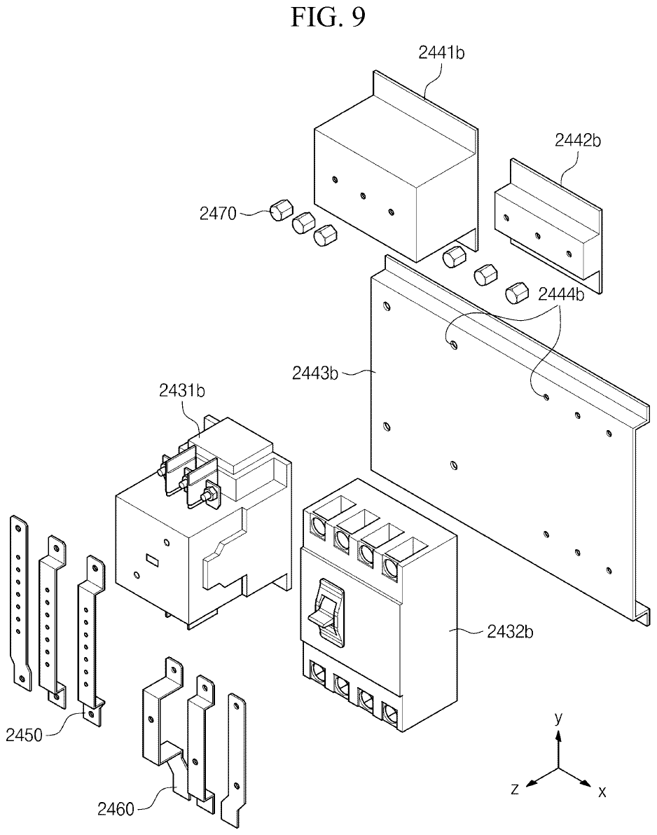

FIG. 6 is a view illustrating a first fastening portion 2440a to which a first power cut-off 2430a is coupled in the charging device 1000 according to an embodiment of the present disclosure. FIG. 7 is a view illustrating a second fastening portion 2440b to which a second power cut-off 2430b is coupled in the charging device 1000 according to an embodiment of the present disclosure. FIG. 8 is an exploded view of FIG. 6. Further, FIG. 9 is an exploded view of FIG. 7.

As described above, in the charging device 1000 according to an embodiment of the present disclosure, the dedicated input module 2420 may be detachably fastened to the one surface 2200a of the inner plate 2200. In this regard, the power cut-off 2430 of the dedicated input module 2420 may include the magnet contactor 2431 and the molded case circuit breaker 2432. Further, the power cut-off 2430 may include the first power cut-off 2430a and the second power cut-off 2430b having different specifications for each country of use.

Referring to FIGS. 6 and 7 together, the first power cut-off 2430a may include a first magnet contactor 2431 and a first molded case circuit breaker 2432, and the second power cut-off 2430b may include a second magnet contactor 2431 and a second molded case circuit breaker 2432. In this regard, the first magnet contactor 2431 and the second magnet contactor 2431, and the first molded case circuit breaker 2432 and the second molded case circuit breaker 2432 may have different specifications, and may also have different sizes and shapes as illustrated in FIGS. 6 and 7.

Accordingly, in the charging device 1000 according to an embodiment of the present disclosure, the fastening portion 2440 may include the first fastening portion 2440a to which the first power cut-off 2430a is coupled and the second fastening portion 2440b to which the second power cut-off 2430b is coupled.

In this regard, the first fastening portion 2440a may include a first-first fastening bracket 2441a, a second-first fastening bracket 2442a, and a third-first fastening bracket 2443a. In addition, the second fastening portion 2440b may include a first-second fastening bracket 2441b, a second-second fastening bracket 2442b, and a third-second fastening bracket 2443b.

As described above, because the first magnet contactor 2431 and the second magnet contactor 2431, and the first molded case circuit breaker 2432 and the second molded case circuit breaker 2432 have the different specifications and the different sizes and shapes, sizes and shapes of the first fastening portion 2440a and the second fastening portion 2440b may also be different from each other.

For example, lengths L1 and L3 of the first-first fastening bracket 2441a and the first-second fastening bracket 2441b in the left and right direction (the x-axis direction) may be different from each other. In addition, heights H1 and H3 of the first-first fastening bracket 2441a and the first-second fastening bracket 2441b in the front and rear direction (the z-axis direction) may be different from each other.

Similarly, lengths L2 and L4 of the second-first fastening bracket 2442a and the second-second fastening bracket 2442b in the left and right direction (the x-axis direction) may be different from each other. In addition, heights H2 and H4 of the second-first fastening bracket 2442a and the second-second fastening bracket 2442b in the front and rear direction (the z-axis direction) may be different from each other.

Furthermore, as illustrated in FIGS. 8 and 9, locations and the number of plurality of coupling holes 2444a defined in the third-first fastening bracket 2443a and locations and the number of plurality of coupling holes 2444b defined in the third-second fastening bracket 2443b may be different from each other. This is also for coupling the first power cut-off 2430a and the second power cut-off 2430b having the different specifications and the different sizes and shapes.

In this regard, as shown in FIGS. 6 to 9, the first input bus bar 2450 and the second input bus bar 2460 may be commonly used for the first power cut-off 2430a and the second power cut-off 2430b having the different specifications and the different sizes and shapes. Similarly, a first insulating member 2470 connecting the first input bus bar 2450 and the second input bus bar 2460 respectively to the first fastening portion 2440a and the second fastening portion 2440b may also be commonly used. This is to minimize the number of components requiring replacement in the dedicated input module 2420.

However, to facilitate the replacement of the dedicated input module 2420, the first input bus bar 2450, the second input bus bar 2460, and the first insulating member 2470 may also be removed from the one surface 2200a of the inner plate 2200 while being connected to the first power cut-off 2430a and the first fastening portion 2440a. In this case, the replacement may be performed while another input bus bar is connected to the second power cut-off 2430b and the second fastening portion 2440b.

Accordingly, the charging device 1000 according to an embodiment of the present disclosure may distinguish the common input module 2410 coupled and fixed to the one surface 2200a of the inner plate 2200 from the dedicated input module 2420 detachably fastened to the one surface 2200a of the inner plate 2200, and replace the dedicated input module 2420 based on the specifications of each country of use, thereby achieving the common use of the charging device 1000.

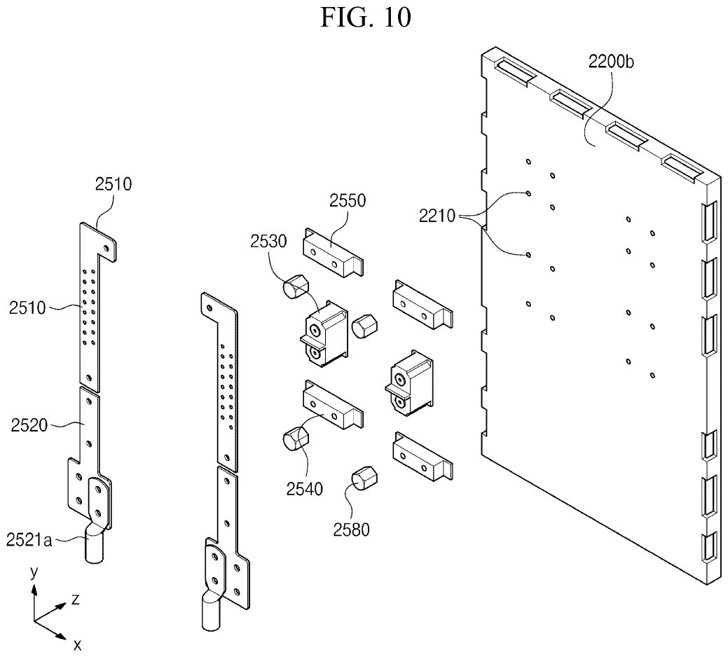

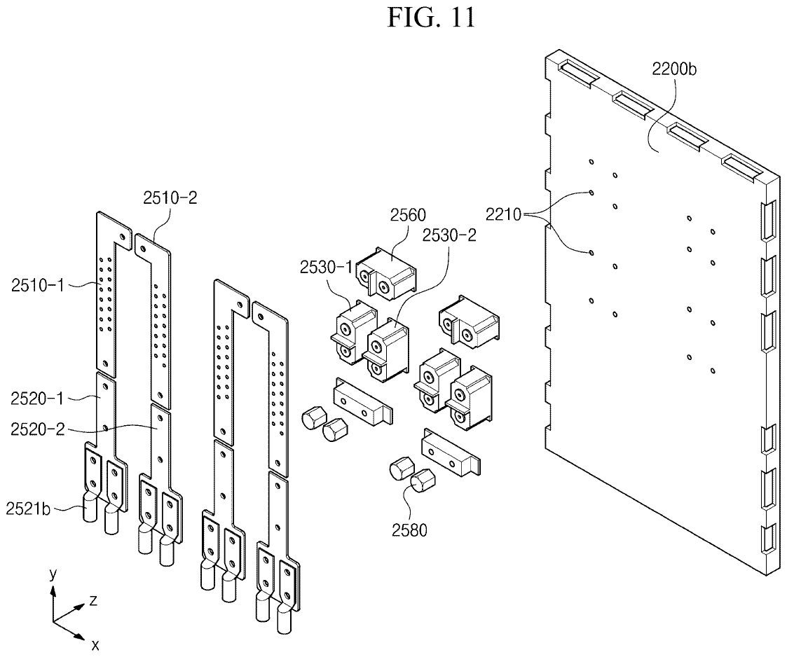

FIG. 10 is an exploded view of the output module 2500 disposed on the other surface 2200b of the inner plate 2200 in the charging device 1000 according to an embodiment of the present disclosure. Further, FIG. 11 is an exploded view of the output module 2500 according to another embodiment disposed on the other surface 2200b of the inner plate 2200 in the charging device 1000 of the present disclosure.

The charging device 1000 according to an embodiment of the present disclosure may include the output module 2500 disposed on the other surface 2200b of the inner plate 2200. In addition, the output module 2500 may be detachably coupled to the other surface 2200b of the inner plate 2200 in a selective manner. To this end, the inner plate 2200 may include a plurality of fastening grooves 2210 defined in the other surface 2200b such that the output module 2500 is detachably fastened.

Referring to FIGS. 4 and 10 together, in the charging device 1000 according to an embodiment of the present disclosure, the output module 2500 may include the first output bus bar 2510 electrically connected to the power module 2300 and the second output bus bar 2520 coupled with the output terminal 2521 electrically connected to the power cable 1200. In addition, a first relay 2530 that electrically connects the first output bus bar 2510 with the second output bus bar 2520 and is fastened to the plurality of fastening grooves 2210 may be included. In addition, the output module 2500 may include a cable 2570 for electrically connecting the power module 2300 with the first output bus bar 2510. Further, as described above with reference to FIG. 1, the power cable 1200 for supplying the power to the dispenser 1100 may be connected to the output terminal 2521.

In addition, in the charging device 1000 according to an embodiment of the present disclosure, the output module 2500 may include a first fixing bracket 2540 coupled to the second output bus bar 2520 and fastened to the plurality of fastening grooves 2210. Further, the output module 2500 may include a second fixing bracket 2550 coupled to the first output bus bar 2510 and fastened to the plurality of fastening grooves 2210. Additionally, the output module 2500 may include a second insulating member 2580 for connecting the first output bus bar 2510 and the second output bus bar 2520 respectively to the first fixing bracket 2540 and the second fixing bracket 2550.

In particular, in the charging device 1000 according to an embodiment of the present disclosure, the accommodation space 2110 may be partitioned via the inner plate 2200, so that the output module 2500 may be disposed on the other surface 2200b of the inner plate 2200. In addition, the placement space of the output module 2500 may be secured via the inner plate 2200 partitioning the accommodation space 2110.

Therefore, the charging device 1000 according to an embodiment of the present disclosure may secure the structure advantageous for placing the plurality of output terminals 2521. In addition, by connecting the power cable 1200 to the plurality of output terminals 2521, the power may be supplied to the at least one dispenser 1100 as described above with reference to FIG. 1, and the charging of the electric vehicle may be performed.

More specifically, as illustrated in FIG. 11, in the charging device 1000 according to an embodiment of the present disclosure, the output module 2500 may include a plurality of first relays 2530-1 and 2530-2, and the plurality of first relays 2530-1 and 2530-2 may be fastened to the plurality of fastening grooves 2210.

Further, a plurality of first output bus bars 2510-1 and 2510-2 and a plurality of second output bus bars 2520-1 and 2520-2 may be electrically connected to each other via the plurality of first relays 2530-1 and 2530-2.

In this case, after removing the second fixing bracket 2550 described above in FIG. 10 from the other surface 2200b of the inner plate 2200, the second relay 2560 for electrically connecting the plurality of first output bus bars 2510-1 and 2510-2 may be fastened to the plurality of fastening grooves 2210.

In addition, referring to FIGS. 10 and 11 together, in the charging device 1000 according to an embodiment of the present disclosure, the output terminal 2521 of the output module 2500 may include a first output terminal 2521a and a second output terminal 2521b having different specifications. This is to correspond to the specification of the power cable 1200 for supplying and distributing the power to the at least one dispenser 1100 described above with reference to FIG. 1.

For example, the first output terminal 2521a illustrated in FIG. 10 may be specified for connecting the power cable 1200 having a specification of 900 Kcmil, and the second output terminal 2521b illustrated in FIG. 11 may be specified for connecting the power cable 1200 having a specification of 700 Kcmil.

Accordingly, the charging device 1000 according to an embodiment of the present disclosure may efficiently supply and distribute the power to the at least one dispenser 1100 via the output module 2500 detachably fastened to the other surface 2200b of the inner plate 2200. In addition, as described above, in response to the replacement of the dedicated input module 2420 having the different specifications for each country of use, the output module 2500 may be fastened to and removed from the other surface 2200b of the inner plate 2200, thereby achieving the common use of the power cabinet 2000.

In addition, the charging device 1000 of the present disclosure may be the power cabinet 2000 or may be the dispenser 1100 as described above. That is, the charging device 1000 of the present disclosure may have the structure applicable to both the power cabinet 2000 and the dispenser 1100, so that the common use thereof may be achieved as some components thereof are mounted in a replaceable manner based on the specifications of each country.

Furthermore, as described above, the charging device 1000 of the present disclosure may also be applied to the integrated charging facility in which the dispenser 1100 and the power cabinet 2000 are integrally formed in the single body shape to perform the charging of the electric vehicle.

That is, a component corresponding to the above-described inner plate 2200 may be disposed in a main body of the integrated charging facility, and a component corresponding to the above-described input module 2400 and a component corresponding to the above-described output module 2500 may be replaceably mounted. Accordingly, the common use of the charging device 1000 across the different countries of use having the different specifications may be achieved.

In summary, the common use of the charging device according to the present disclosure may be achieved as some components of the input module and the output module electrically connected to the power module are mounted in a replaceable manner based on the specifications. In addition, the multiple electronic components may be efficiently disposed by partitioning the accommodation space via the inner plate to place the input module on the one surface of the inner plate and the output module on the other surface of the inner plate. In addition, by securing the placement space of the output module via the inner plate partitioning the accommodation space, a connection space of the power cable for supplying the power to the plurality of dispensers may be sufficiently secured.

The above detailed description is to be construed in all aspects as illustrative and not restrictive. The scope of the present disclosure should be determined by reasonable interpretation of the appended claims and all changes coming within the equivalency range of the present disclosure are intended to be embraced in the scope of the present disclosure.

What is claimed is:

1. A charging device comprising:
a casing comprising:
a space where a power module is mounted, and
an accommodation space where an input module and an output module electrically connected to the power module are located; and
an inner plate partitioning the accommodation space of the casing, the inner plate having the input module disposed on one surface thereof, and having the output module disposed on an opposite surface thereof,
wherein the input module is detachably coupled to the one surface of the inner plate in a selective manner, and the output module is detachably coupled to the opposite surface of the inner plate in a selective manner.

2. The charging device of claim 1, wherein the input module includes:
a common input module coupled to and fixed to the one surface of the inner plate; and
a dedicated input module detachably fastened to the one surface of the inner plate.

3. The charging device of claim 2, wherein the dedicated input module includes:
a power cut-off element configured to block power of the power module; and
a fastener coupled with the power cut-off element and detachably fastened to the one surface of the inner plate.

4. The charging device of claim 3, wherein the power cut-off includes:
a magnet contactor electrically connected to the power module; and
a molded case circuit breaker electrically connected to the magnet contactor.

5. The charging device of claim 4, wherein the power cut-off includes a first power cut-off and a second power cut-off having different specifications.

6. The charging device of claim 5, wherein the fastener includes a first fastener coupled with the first power cut-off and a second fastener coupled with the second power cut-off.

7. The charging device of claim 4, wherein the dedicated input module includes:
a first input bus bar electrically connecting the power module with the magnet contactor; and
a second input bus bar electrically connecting an external power source with the molded case circuit breaker.

8. The charging device of claim 7, wherein the fastener includes:
a first fastening bracket coupled with the first input bus bar;
a second fastening bracket coupled with the second input bus bar; and
a third fastening bracket coupled with the magnet contactor and the molded case circuit breaker.

9. The charging device of claim 2, wherein the common input module includes:
a cable connector for electrically connecting the power module with the dedicated input module; and
an earth leakage circuit breaker for blocking a leakage current.

10. The charging device of claim 1, wherein the inner plate includes a plurality of fastening grooves defined in the opposite surface thereof for the output module to be detachably fastened.

11. The charging device of claim 10, wherein the output module includes:
a first output bus bar electrically connected to the power module;
a second output bus bar coupled with an output terminal electrically connected with a power cable; and
a first relay electrically connecting the first output bus bar with the second output bus bar, wherein the first relay is fastened to the plurality of fastening grooves.

12. The charging device of claim 11, wherein the output module includes a first fixing bracket coupled with the second output bus bar and fastened to the plurality of fastening grooves.

13. The charging device of claim 12, wherein the output module includes a second fixing bracket coupled with the first output bus bar and fastened to the plurality of fastening grooves.

14. The charging device of claim 11, wherein the first relay includes a plurality of first relays fastened to the plurality of fastening grooves,
wherein the first output bus bar and the second output bus bar respectively include a plurality of first output bus bars and a plurality of second output bus bars electrically connected to each other via the plurality of first relays.

15. The charging device of claim 14, wherein the output module includes a second relay electrically connecting the plurality of first output bars to each other and fastened to the plurality of fastening grooves.

16. The charging device of claim 11, wherein the output terminal includes a first output terminal and a second output terminal having different specifications.

17. The charging device of claim 1, wherein the casing is formed in a shape with open front and rear sides,
wherein the inner plate partitions the accommodation space of the casing in a front and rear direction.

18. The charging device of claim 17, wherein the accommodation space of the casing is defined under the mounted power module.

19. The charging device of claim 1, further comprising a dispenser configured to receive power converted via the power module and to charge an electric vehicle.

20. The charging device of claim 19, wherein the dispenser includes a plurality of dispensers configured to receive the power via a plurality of power cables connected to the output module.
